(19) United States
(12) Patent Application Publication
(10) Pub. No.: US 2012/0076523 A1
(43) Pub. Date: Mar. 29, 2012

(54) PRINTER

(75) Inventor: Naosato KOJIMA, Tokyo (JP)

(73) Assignee: OKI DATA CORPORATION, Tokyo (JP)

(21) Appl. No.: 13/241,512

(22) Filed: Sep. 23, 2011

(30) Foreign Application Priority Data
Sep. 28, 2010 (JP) 2010-216860

(51) Int. Cl. G03G 15/00; G03G 15/20

(52) U.S. Cl. 399/70; 399/81

(57) ABSTRACT

A printer having operational modes including a sleep mode, includes, an operation display unit, a sleep-mode setting-value table in which a warm-up time from the sleep mode and an estimated amount of power consumption per certain unit of time in the sleep mode are stored in association with values for setting items to set up conditions of the sleep mode, and a first setup unit. The first setup unit is configured to, when setting up the conditions of the sleep mode, extract the estimated amount of power consumption and the warm-up time in reference to the sleep-mode setting-value table by using, as a key, values of the setting items inputted through the operation display unit, and display the extracted estimated amount of power consumption and warm-up time in the operation display unit.

### CROSS REFERENCE TO RELATED APPLICATIONS

This application claims priority based on 35 USC 119 from prior Japanese Patent Application No. 2010-216860 filed on Sep. 28, 2010, entitled “PRINTER”, the entire contents of which are incorporated herein by reference.

### BACKGROUND OF THE INVENTION

1. Field of the Invention

The invention relates to a printer with a power saving function.

2. Description of Related Art

Conventionally, printers have a power saving function. With a power saving mode transition time preset, the printer reduces power supplied to a fuser unit and the like that consume large power and enters a sleep mode, i.e., power-saving mode to save power consumption if the printer receives no print data from a higher-level device, such as a PC, for over a period of the preset power saving mode transition time since the completion of the last print job.

In one of the known techniques for such printers, a printer is configured to calculate and display an amount of power consumption and thereby to allow a user to know the amount of power consumption. For instance, Japanese Patent Application Publication No. 2009-107141 discloses a technique by which a printer enables a user to judge whether the current power consumption is adequate by displaying an actual amount of power consumption and a standard value defined by the International Energy Star Program.

### SUMMARY OF THE INVENTION

Such a conventional printer, however, has a problem in that when a user sets setting values for power saving, the user has difficulty in recognizing the power saving effect of the setting values or in recognizing the trade-off between the power-saving effect and warm up time.

A first aspect of the invention is a printer having operational modes including a sleep mode in which power consumption is saved, the printer including: an operation display unit configured to receive data inputted by a user and to display a notification to the user; a sleep-mode setting-value table in which a warm-up time from the sleep mode and an estimated amount of power consumption per certain unit of time in the sleep mode are stored in association with each combination of values for setting items to set up conditions of the sleep mode; and a first setup unit configured to, when setting up the conditions of the sleep mode, extract the estimated amount of power consumption and the warm-up time in reference to the sleep-mode setting-value table by using, as a key, values of the setting items inputted by the user through the operation display unit, display the extracted estimated amount of power consumption and warm-up time in the operation display unit, and confirm the values of the setting items in the operation display unit as the set-up values in response to an operation by the user through the operation display unit.

A second aspect of the invention is a printer having operational modes including a sleep mode in which power consumption is saved, the printer including: an operation display unit configured to receive data inputted by a user and to display a notification to the user; an economy {“eco”) mode setting-value table in which eco mode levels with different power saving levels are stored and values of setting items, an estimated amount of power consumption, and a warm-up time, each of which is set for each eco mode level, are stored; and a second setup unit configured to, when setting up the conditions of the sleep mode, extract the values of the setting items with reference to the eco mode setting-value table by using, as a key, the eco mode level inputted by the user through the operation display unit, and confirm the extracted values of the setting items as the set-up values.

According to the first aspect, when the user sets up (selects) the values of the setting items (e.g., transition time to the sleep mode and a heater temperature), the operation display unit displays the estimated amount of power consumption per certain unit of time in the sleep mode, and the estimated warm-up time. Accordingly, the user can recognize the estimated amount of power consumption and the estimated warm-up time as guides for setting up the conditions of the sleep mode. Consequently, the user can adequately trade off the conveniences and the power-saving of the printer.

According to the second aspect, the user can set up the value of each setting item in a simple manner by selecting the eco mode level. In addition, the user can make the operation display unit display the contents of the eco mode setting-value table. Consequently, the user can trade off the conveniences and the power-saving more easily and adequately.

### BRIEF DESCRIPTION OF THE DRAWINGS

FIG. 1 is a configuration diagram schematically showing printer 10 according to a first embodiment.

FIG. 2 is a diagram illustrating an example of sleep-mode setup screen 20-1 displayed on operation display unit 14 shown in FIG. 1.

FIG. 3 is a diagram illustrating an example of sleep-mode setup screen 20-2 displayed on operation display unit 14 shown in FIG. 1 when the sleep-mode transition time is selected.

FIG. 4 is a diagram illustrating an example of sleep-mode setup screen 20-3 displayed on operation display unit 14 shown in FIG. 1 when the heater temperature is selected.

FIG. 5 is a chart illustrating sleep-mode setting-value table 30 stored in flash memory 18 shown in FIG. 1.

FIG. 6 is a flowchart illustrating operations of display-setup program 16a at the time when sleep mode on button 21a is pressed according to the first embodiment.

FIG. 7 is a flowchart illustrating operations to display a sleep-mode transition-time list table when the sleep mode is set up according to the first embodiment.

FIG. 8 is a flowchart illustrating the operations to display a heater-temperature list table when the sleep mode is set up according to the first embodiment.

FIG. 9 is a configuration diagram illustrating a general configuration of printer 10A according to a second embodiment.

FIG. 10 is a diagram illustrating an example of eco mode setup screen 50 according to the second embodiment.

FIG. 11 is a chart illustrating eco mode setting-value table 60 according to the second embodiment.

FIG. 12 is a diagram illustrating an example of eco mode setup help screen 70 displayed when help button 52 shown in FIG. 10 is pressed.

FIG. 13 is a flowchart illustrating the operations of eco mode setup program 16b when an eco mode is set up according to the second embodiment.

FIG. 14 is a flowchart illustrating the operations of eco mode setup program 16b at the time when eco mode setup help screen 70 is displayed.

### DETAILED DESCRIPTION OF THE EMBODIMENTS

Descriptions are provided hereinbelow for embodiments based on the drawings. In the respective drawings, the same constituents are designated by the same reference numerals and duplicate explanation concerning the same constituents is omitted. All of the drawings are provided to illustrate the respective examples only.

### First Embodiment

### (Configuration of Image Formation Apparatus of First Embodiment)

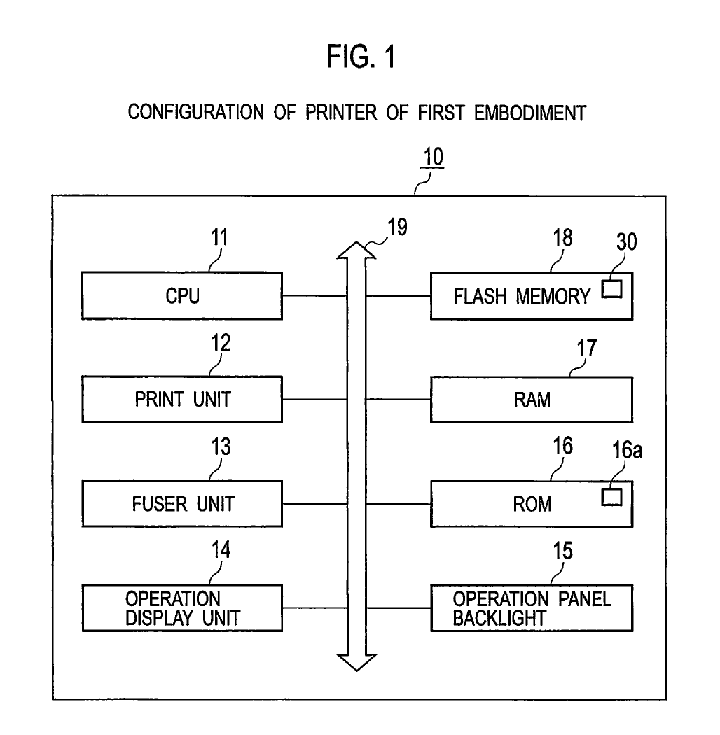

FIG. 1 is a configuration diagram schematically showing printer 10 according to a first embodiment. Printing apparatus in this first embodiment is, for instance, an electrophotographic page printer having various operational modes. Specifically, the operational modes are: a print mode in which printer 10 executes a print job; a standby mode in which printer 10 stands by for the next print job after completing the last print job; and a sleep mode in which printer 10 reduces the consumption of the power by saving the power consumption when printer 10 receives no print request for a predetermined length of time after completing the last print job.

Printing apparatus 10 includes controller (such as a central processing unit hereinafter, referred to as “CPU”) 11, print unit 12, fuser unit 13, operation display unit 14, operation-panel backlight 15, read only memory (hereinafter, referred to as “ROM”) 16, random access memory (hereinafter, referred to as “RAM”) 17, and flash memory 18. These components are connected to one another via bus 19.

CPU 11 implements various functions of printer 10 by executing control programs stored in ROM 16. CPU 11 performs an overall control of various units of printer 10 in accordance with an operational mode. For instance, in the sleep mode, CPU 11 reduces an operation clock to save power consumption.

Print unit 12 has a function of forming images on a print medium such as a paper sheet under the control by CPU 11. Fuser unit 13 has a function of fixing the toner images formed on the print medium to the print medium by applying heat and pressure. Fuser unit 13 uses a heater for the heat fixing and thus consumes large power. In the sleep mode, the supply of the power to the fuser unit 13 is cut off or reduced in accordance with the control by CPU 11 to save power consumption.

Operation display unit 14 includes a liquid crystal display device (hereinafter, referred to as the “LCD”) and a touch panel. The LCD displays various kinds of screens containing texts, figures, and the like. The touch panel is provided on the LCD and is used to input various kinds of information. Operation display unit 14 is configured to display various kinds of touch-panel buttons used to set up the sleep mode, and to display data such as setting-value options for various kinds of setting items. Operation-panel backlight 15 is a light-source unit to illuminate, from the back side, the LCD of operation display unit 14. While printer 10 is working, the operation-panel backlight 15 is supplied with power and illuminates operation display unit 14. In contrast, while printer 10 is in the sleep mode, the power supply to operation-panel backlight 15 is cut off.

ROM 16 is a memory to store, in advance, various kinds of control programs to control printer 10. One of the control programs is first setup program (e.g., display-setup program) 16a. First setup program 16a makes operation display unit 14 display both the estimated amount of power consumption in the sleep mode and the warm-up time from the sleep mode. Then, first setup program 16a confirms values selected by the user on operation display unit 14 for the setting items as set-up values. ROM 16 is a non-volatile memory capable of keeping the stored content even if printer 10 is powered OFF.

RAM 17 is a memory to store various kinds of data to be processed or the data being processed by CPU 11 executing the control programs. RAM 17 is a volatile memory that deletes the stored data if the power supply is cut off.

Flash memory 18 stores sleep-mode setting-value table 30. Sleep-mode setting value table 30 stores data on the sleep-mode transition time, the heater temperature of the heater in fuser unit 13, the estimated amount of power consumption per certain unit of time, and the warm-up time. The estimated amount of power consumption is obtained for each transition time and each heater temperature on the basis of experiments and calculations conducted following predetermined standards defining energy-saving criteria for various apparatuses (e.g., the standards defined by the International Energy Star Program). The warm-up time is the length of time to switch from the sleep mode to the print mode.

The International Energy Star Program is an international energy conservation system concerning office equipment undertaken in seven countries of the world. The International Energy Star Program provides different reference formulas for different categories of products. The standard value for each printer is calculated by assigning a print speed value into the appropriate reference formula. The actual measured values are calculated using a formula for calculating TEC (typical electricity consumption) as defined by the International Energy Star Program. The amount of power consumed in typical normal operation for per certain unit time is measured as the standard value of power consumption [KWh]. The standard values defined by the International Energy Star Program and the actual measured values measured by the formula for calculating TEC are used as the criteria for the measurement of the energy-saving performance.

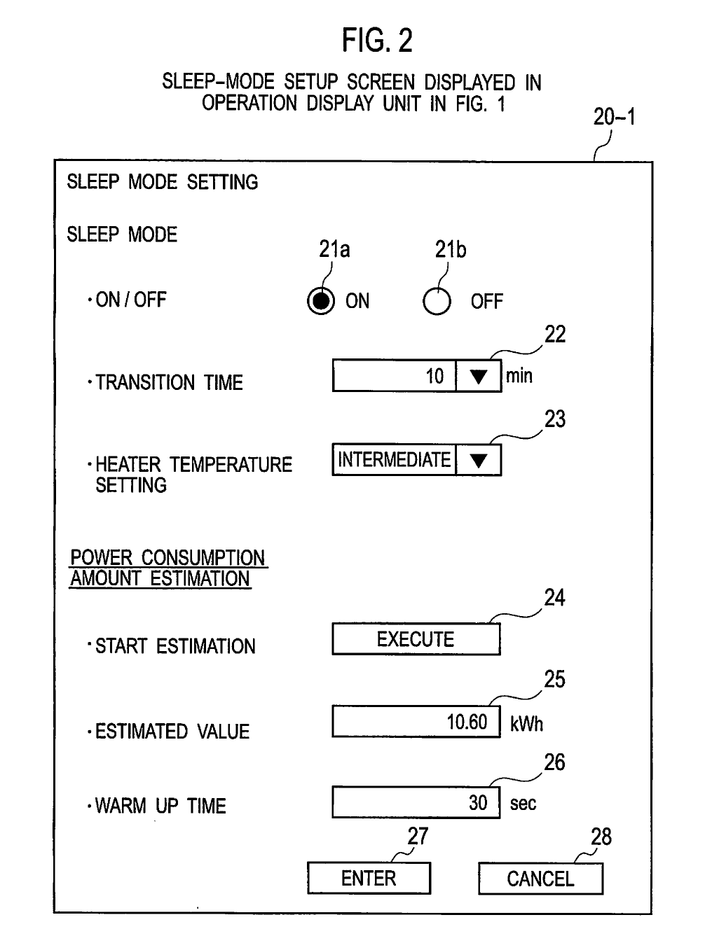

FIG. 2 is a diagram illustrating an example of sleep-mode setup screen 20-1 displayed on operation display unit 14 shown in FIG. 1.

In sleep-mode setup screen 20-1, on button 21a and off button 21b are buttons with indicator lamps to set on/off of the sleep mode. When one of on button 21a and off button 21b is selected and is pressed, the pressed button is lighted on, and the sleep mode is set to be on or off.

If on button 21a is selected, and there is no print request for a preset transition time after the last print job is completed, printer 10 makes a transition to the sleep mode. In contrast, if the off button 21b is selected, no transition to the sleep mode occurs even after the preset transition time elapses after the last print job is completed.

Transition-time selection button 22 is a button to be used to select the length of time that it takes for printer 10 to make a transition to the sleep mode after the completion of the last print job without receiving any printing data from any external devices or any higher-level devices, such as a computer. If the black-triangle mark is pressed, transition times are displayed in sequence on the left-hand side of the black-triangle mark. Heater-temperature selection button 23 has a function of setting the temperature of the heater of fuser unit 13 at the time when printer 10 is in the sleep mode. The temperature of the heater is set at a high temperature, an intermediate temperature, or a low temperature. In addition, still another option is available which cuts off the power supply to the heater altogether. If the black-triangle mark is pressed, the classes, specifically, High, Intermediate, Low, and OFF, corresponding to the heater temperatures, appear in sequence also on the left-hand side of the black-triangle mark.

In the sleep mode, a higher temperature of the heater increases the amount of power consumed, but shortens the warm-up time from the sleep mode. In contrast, a lower temperature of the heater of printer 10 in the sleep mode reduces the amount of power consumed, but prolongs the warm-up time from the sleep mode .

Execute button 24 has a function of making display-setup program 16a execute the calculation of the estimated amount of power consumed [KWh] by printer 10 and the warm-up time [in seconds, “sec”] from the sleep mode. If execute button 24 is pressed, display-setup program 16a calculates the estimated amount of power consumption and the warm-up time on the basis of the transition time selected with transition-time selection button 22 and the heater temperature selected with heater-temperature selection button 23.

The estimated amount of the power consumed [KWh] thus calculated is displayed in estimated-value display area 25. The warm-up time [sec] thus calculated is displayed in warm-up-time display area 26.

Enter button 27, when pressed, functions to confirm the transition time selected by the user with transition-time selection button 22 and the heater temperature selected by the user with heater-temperature selection button 23 as the set-up values. Cancel button 28, when pressed, functions to cancel the set-up values of the transition time and the heater temperature and set default values for those items.

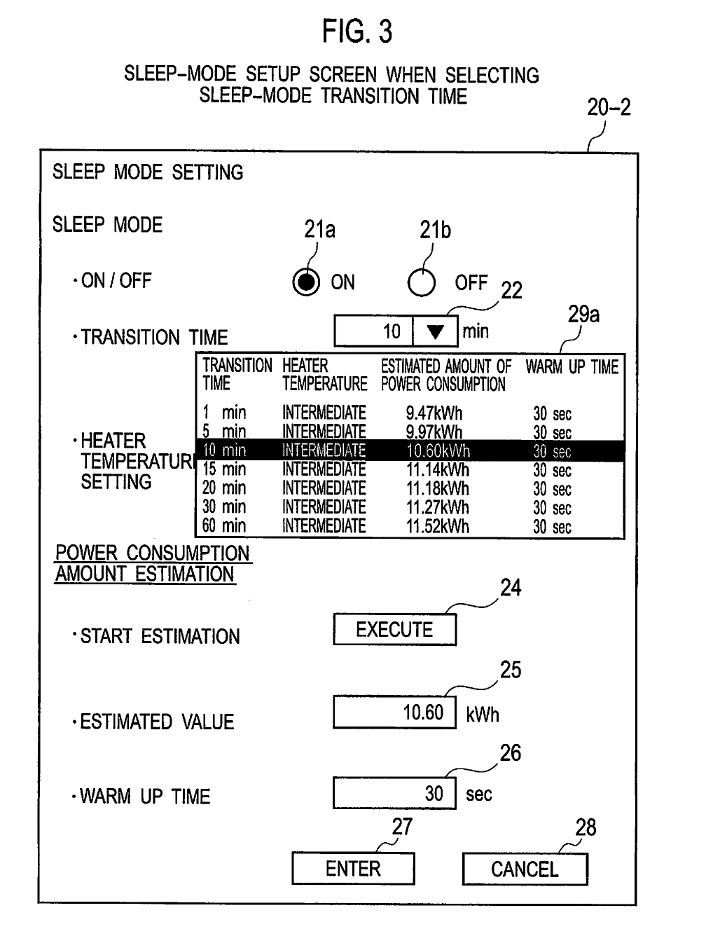

FIG. 3 is a diagram illustrating an example of sleep-mode setup screen 20-2 displayed on operation display unit 14 shown in FIG. 1 when the sleep-mode transition time is selected.

Now, assume a case where, on sleep-mode setup screen 20-2, a transition time, e.g., 10 minute, is selected with transition-time selection button 22. In this case, display-setup program 16a creates a transition-time list table which uses the already set-up heater temperature (e.g., the Intermediate temperature) as a key to provide some options for the transition time, the estimated amount of power consumption, and the warm-up time. The transition-time list table is displayed in transition-time list-table display area 29a, and can be used as a guide for setting-up those items. Of all the listed entries, the row of the 10-minute transition time selected by the user is highlighted or is displayed in reversed colors. Several rows preceding or following the 10-minute row, display other transition time options available, e.g., 1 minute, 5 minutes, 15 minutes, 20 minutes, 30 minutes, and 60 minutes.

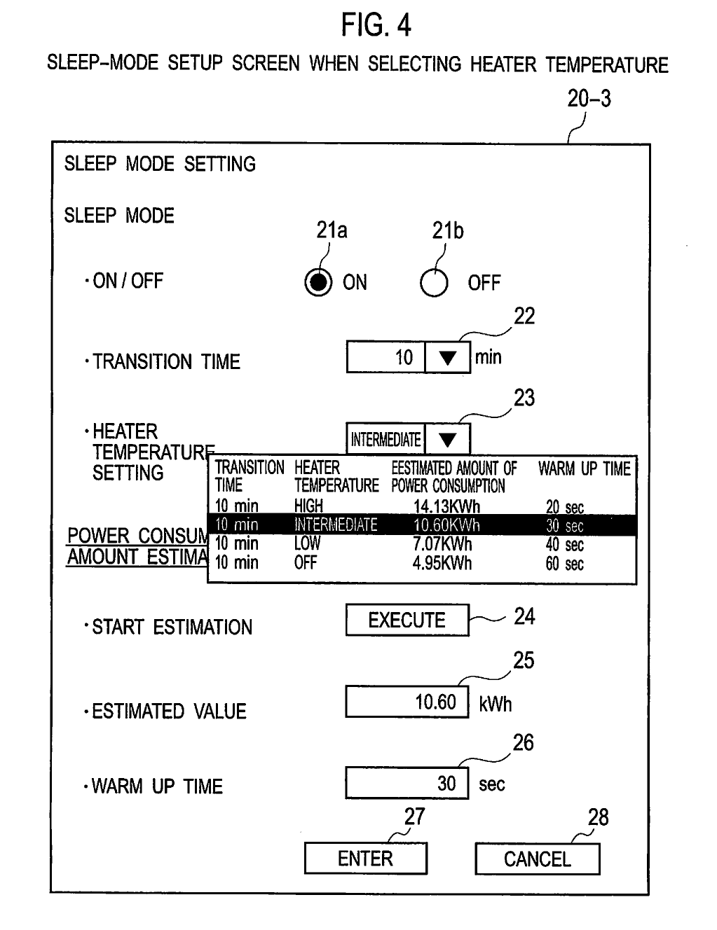

FIG. 4 is a diagram illustrating an example of sleep-mode setup screen 20-3 displayed on operation display unit 14 shown in FIG. 1 when the heater temperature is selected.

Now, assume a case where on sleep-mode setup screen 20-3, a heater temperature (e.g., the Intermediate temperature) is selected with heater-temperature selection button 23. In this case, display-setup program 16a creates a list table which uses the already set-up transition time, e.g., 10 minutes, as a key to provide some options of the heater temperature, the estimated amount of power consumption, and the warm-up time. The list table is displayed in heater-temperature list-table display area 29b, and can be used by the user as a guide for setting-up those items. Of all the listed entries, the row of the heater temperature selected by the user (e.g., Intermediate) is highlighted or displayed in reverse colors to make the row more noticeable. Several rows preceding or following the row of the intermediate heater temperature, display other heater temperatures, e.g., the high temperature, the low temperature, and OFF.

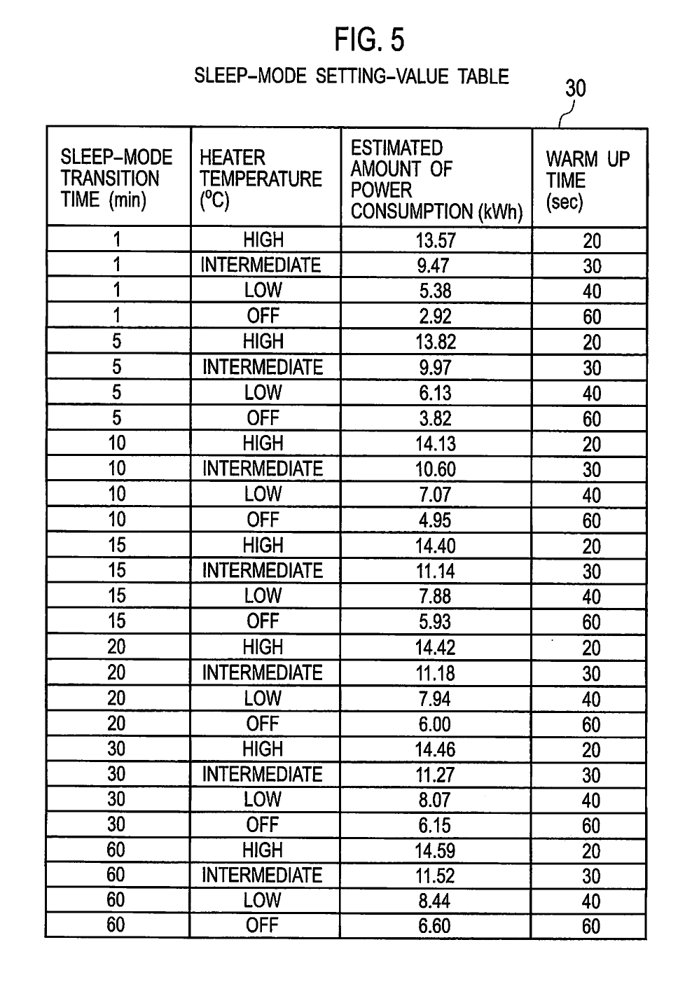

FIG. 5 is a chart illustrating sleep-mode setting-value table 30 stored in flash memory 18 shown in FIG. 1.

Sleep-mode setting-value table 30 contains data on the sleep-mode transition time [in minutes, “min”], the heater temperature [° C.] of fuser unit 13, the estimated amount of power consumption [KWh], and the warm-up time [sec] from the sleep mode. Both the estimated amount of power consumption [KWh] and the warm-up time from the sleep mode [sec] are obtained by experiments and calculations according to the International Energy Star Program.

### (Operations of First Embodiment)

The operations of this first embodiment in the following cases (1) to (3) are described below.

(1): The user performs an operation on the sleep-mode setup screen 20 to setup the sleep mode, the transition time and the heater temperature, and then presses execute button 24 to make display-setup program 16a calculate and display the estimated amount of the power consumption and that of the warm-up time.

(2): When the sleep-mode transition time is selected, a list containing some options of the sleep-mode transition time together with their corresponding estimated amounts of power consumption and their corresponding warm-up times is displayed.

(3) : When the heater temperature is selected, a list containing some options of the heater temperature together with their corresponding estimated amounts of power consumption and their corresponding warm-up times is displayed.

(1) : Calculation and Display of Estimated Power Consumption and Estimated Warm-Up Time

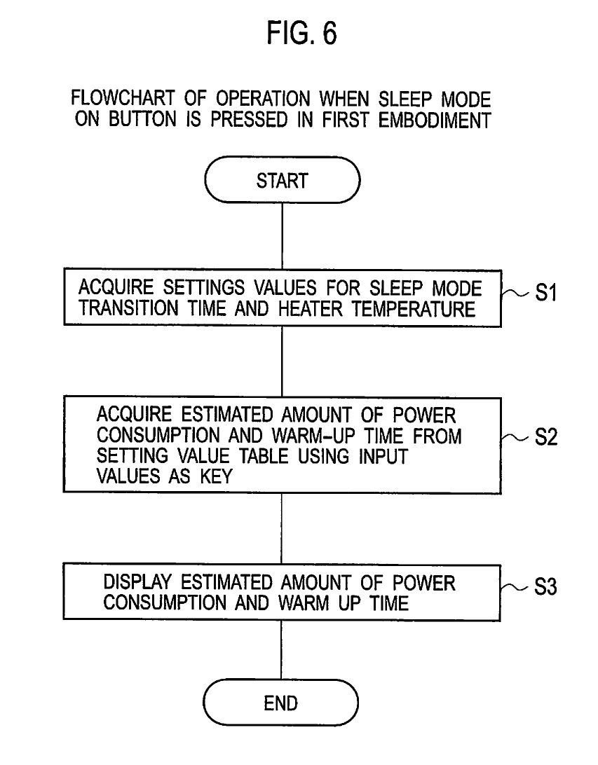

FIG. 6 is a flowchart illustrating operations of display-setup program 16a at the time when sleep mode on button 21a is pressed according to the first embodiment.

The user brings up sleep-mode setup screen 20-1 by use of operation display unit 14, and sleep-mode setup screen 20-1 is displayed as shown in FIG. 2. Then, the user selects sleep mode ON button 21a to set the sleep mode to be on in printer 10.

At step S1, the user inputs (selects) a value of the transition time and a value of the heater temperature, and display-setup program 16a acquires these values. At step S2, when the user presses execute button 24, display-setup program 16a uses the input values as keys to acquire, from sleep-mode setting-value table 30 stored in flash memory 18, the corresponding estimated amount of power consumption and the corresponding warm-up time from the sleep mode.

At step S3, display-setup program 16a displays the acquired value of the estimated amount of power consumption in estimated-value display area 25 of sleep-mode setup screen 20-1, and displays the acquired value of the warm-up time in warm-up-time display area 26.

Though not illustrated in FIG. 6, the user then presses enter button 27 to make display-setup program 16a recognize the input values as valid, and confirms the set-up value as their respective set-up values.

(2): Display of Transition-Time List Table

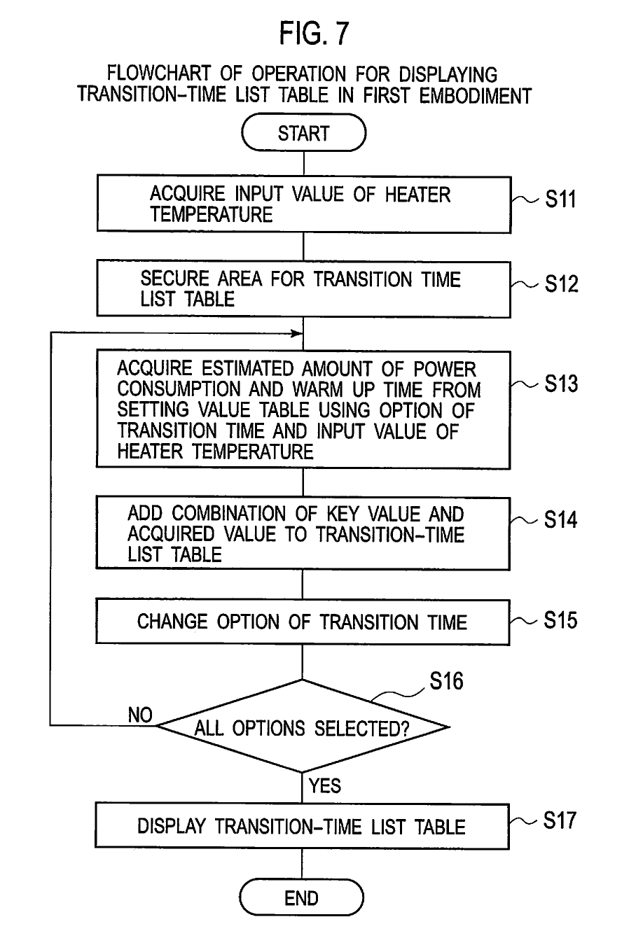

FIG. 7 is a flowchart illustrating the operations to display the sleep-mode transition-time list table when the sleep mode is set up according to the first embodiment.

The description of FIG. 7 is provided on the assumption that the operations described by referring to FIG. 6 have already been performed. Specifically, the sleep mode is set to be ON in printer 10, and both the transition time and the heater temperature have been set up.

As sleep-mode setup screen 20-2 in FIG. 3 shows, the user has selected the sleep mode to be ON, and both the already set-up transition time and the already set-up heater temperature are displayed.

At step S11, when the user presses transition-time selection button 22, display-setup program 16a acquires the already set-up value (set-up value) of the heater temperature (e.g., the Intermediate temperature). At step S12, an area to display transition-time list table in sleep-mode setup screen 20-2 is secured in RAM 17.

At step S13, both the initial value of the sleep-mode transition time, e.g., 1 minute, and the already set-up value of the heater temperature, specifically, Intermediate, are used as keys to acquire the corresponding estimated amount of power consumption (13.57 [KWh]) and the corresponding warm-up time (20 [sec]) from sleep-mode setting-value table 30 stored in flash memory 18. At step S14, a combination of key values (transition time=1 minute, and heater temperature=intermediate) and the acquired values (estimated amount of power consumption=13.57 [KWh], and warm-up time=20 [sec]) is added to the transition-time list table.

At step S15, the option of the transition time is changed, for example, to 5 [min]. At step S16, whether or not all of the options have been selected is judged. Since not all of the options have been selected yet, the process at step S13 is performed again and the processes at steps S13 and S14 are performed repeatedly for the number of times that is equal to the number of the options for the sleep-mode transition time (6 times for 5 minutes, 10 minutes, 15 minutes, 20 minutes, 30 minutes, and 60 minutes).

If, at step S16, it is judged that all of the options have been performed, the process at step S17 is performed next. Specifically, at step S17, the transition-time list table is displayed in transition-time list-table display area 29a on sleep-mode setup screen 20-2.

Though not illustrated in FIG. 7, the user then presses enter button 27 to make display-setup program 16a recognize the input values as valid, and confirm the set-up value as their respective set-up values.

(3) : Display of Heater Temperature List Table

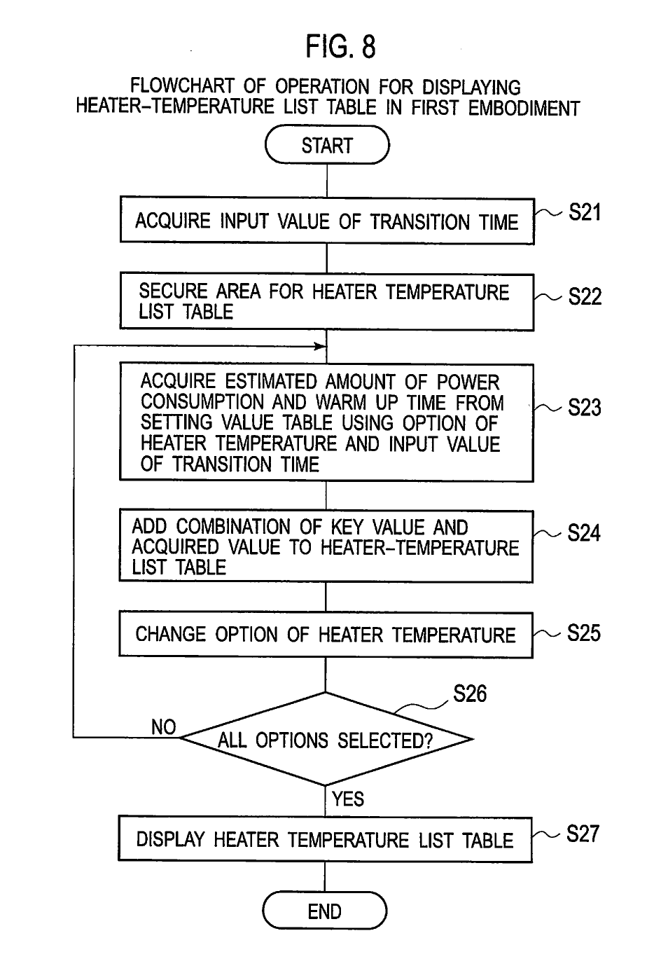

FIG. 8 is a flowchart illustrating the operations to display a heater-temperature list table when the sleep mode is set up according to the first embodiment.

The description of FIG. 8 is provided on the assumption that the operations described by referring to FIG. 6 have already been performed. Specifically, the sleep mode is set to be ON in printer 10, and both the transition time and the heater temperature have been set up.

As sleep-mode setup screen 20-3 in FIG. 4 shows, the user has made the selection to set the sleep mode to be ON, and both the already set-up transition time and the already set-up heater temperature are displayed.

At step S21, when the user presses heater temperature selection button 23, display-setup program 16a acquires the already set-up value of the transition time, e.g., 10 minutes. At step S22, an area to display the heater temperature list table in sleep-mode setup screen 20-3 is secured in RAM 17.

At step S23, both the already set sleep-mode transition time, e.g., 10 minute, and the initial value of the heater temperature (e.g., high) are used as keys to acquire the corresponding estimated amount of power consumption (14.13 [KWh]) and the corresponding warm-up time (20 [sec]) from sleep-mode setting-value table 30 stored in flash memory 18. At step S24, a combination of key values (transition time=10 minute, and heater temperature=high) and the acquired values (estimated amount of power consumption=14.13 [KWh], and warm-up time=20 [sec]) is added to the heater temperature list table.

At step S25, the option of the heater temperature is changed to, for instance, intermediate. At step S26, whether or not all of the options have been selected is judged. If not all of the options have been selected yet, the process returns to step S23 and the processes at steps S23 and S24 are performed repeatedly for the number of times that is equal to the number of the options for the heater temperature (e.g., three times for intermediate, low, and OFF).

If, at step S26, it is judged that all of the options have been performed, the process at step S27 is performed next. Specifically, at step S27, the heater temperature list table is displayed in transition-time list-table display area 29b on heater temperature setup screen 20-3.

Though not illustrated in FIG. 8, the user then presses enter button 27 to make display-setup program 16a recognize the input values as valid, and confirm the set-up value as their respective set-up values.

### (Effects of First Embodiment)

Print apparatus 10 according to the first embodiment has the following effects (a) to (c).

(a): Since the user's selection of the sleep-mode transition time and of the heater temperature makes display-setup program 16a display both the estimated amount of the power consumption and the estimated warm-up time on operation display unit 14, the user can easily recognize the effect that the set-up values have on the power saving. Accordingly, the user can trade off the conveniences and the power-saving more adequately.

(b): The user's selection of the transition time makes display-setup program 16a use the already set-up heater temperature as a key to display, in transition-time list-table display area 29a, the transition-time list table containing some options of the transition time, those of the estimated amount of power consumption, and those of the warm-up time, all of which the user can refer to as guides for the setup. Accordingly, the user can adequately trade off the conveniences and the power-saving more easily.

(c): The user's selection of the transition time makes display-setup program 16a use the already set-up transition time as a key to display, in transition-time list-table display area 29a, the transition-time list table containing some options of the heater temperature, those of the estimated amount of power consumption, and those of the warm-up time, all of which the user can refer to as guides for the setup. Accordingly, the user can adequately trade off the conveniences and the power-saving more easily.

### Second Embodiment

### (Configuration of Second Embodiment)

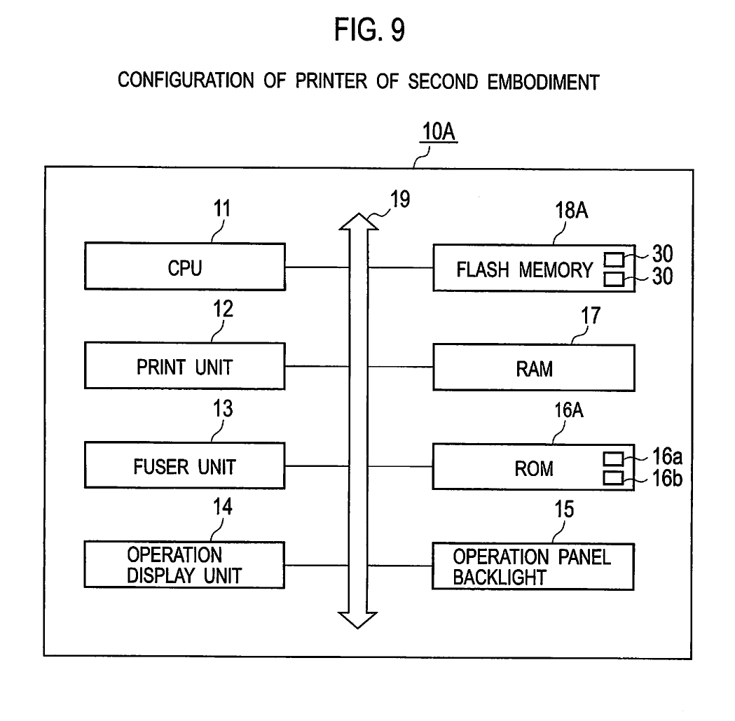

FIG. 9 is a configuration diagram schematically illustrating printer 10A according to a second embodiment. If an element in FIG. 9 is identical to the one shown in FIG. 1 for the first embodiment, such an element is denoted by the same reference numeral used in FIG. 1.

Like printer 10 of the first embodiment, printer 10A of this second embodiment has the sleep mode. The sleep mode mentioned above is referred to as a mode in which the consumption of power is reduced by cutting off or reducing the power supplied to some of the components in the apparatus.

Print apparatus 10A includes eco mode setup table 60, which stores combinations of several levels of eco mode (hereinafter, referred to as “eco mode levels”) indicating different levels of power saving in the sleep mode, several setting-value options for each of the setting items, the estimated amount of power consumption, and the warm-up time. The entries of eco mode setup table 60 are predetermined so as to correspond to the eco mode levels. The setting items in the eco mode are the sleep-mode transition time, the heater temperature, and the selection from color printing and monochrome printing.

Print apparatus 10A of this second embodiment includes CPU 11, print unit 12, fuser unit 13, operation display unit 14, operation-panel backlight 15, and RAM 17, all of which are identical to their respective counterparts included in printer 10 of the first embodiment. Print apparatus 10A of this second embodiment also includes ROM 16A and flash memory 18A, which are different from their corresponding ones included in printer 10 of the first embodiment. All of these above-mentioned components of printer 10A are connected to one another via bus 19.

ROM 16A stores in advance, various kinds of control programs to control printer 10A. ROM 16A stores first setup program 16a, as one of the control programs, similar to the one in the first embodiment and makes operation display unit 14 display both the estimated amount of power consumption in the sleep mode and the warm-up time from the sleep mode, and second setup program (e.g., eco mode setup program) 16b.

Flash memory 18A is a memory to store sleep-mode setting-value table 30 like the one in the first embodiment, eco mode setting-value table 60, and the like.

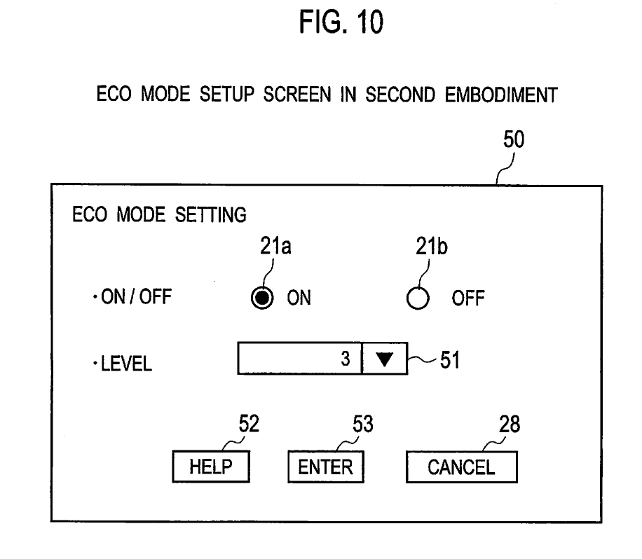

FIG. 10 is a diagram illustrating an example of eco mode setup screen 50 according to the second embodiment.

ON button 21a and OFF button 21b are buttons with indicator lamps and are used to set on/off of the sleep mode. When one of ON button 21a and OFF button 21b is selected and is pressed, the lamp for the pressed button is turned ON, and the sleep mode is set to be on or off.

If ON button 21a is selected, and there is no print request for a preset transition time since the completion of the last print job, printer 10A makes a transition to the sleep mode. In contrast, if the OFF button 21b is selected, no transition to the sleep mode occurs even after the preset transition time is elapsed since the completion of the last print job.

Level-setup button 51 is a button used to set up the level of the eco mode. A higher level results in higher effects on power saving, but prolongs the warm-up time from the sleep mode. If the user presses the black-triangle mark, the levels of the eco mode appear in sequence on the left-hand side of the black-triangular button.

Help button 52 is used for displaying a help screen when the eco mode is set up. Enter button 53 has a function of making the selected level setting valid and of confirming the values of the associated setting items as their respective set-up values. Cancel button 54 has a function of cancelling the set-up value of the transition time and that of the heater temperature, and setting up default values for those items instead when cancel button 54 is pressed.

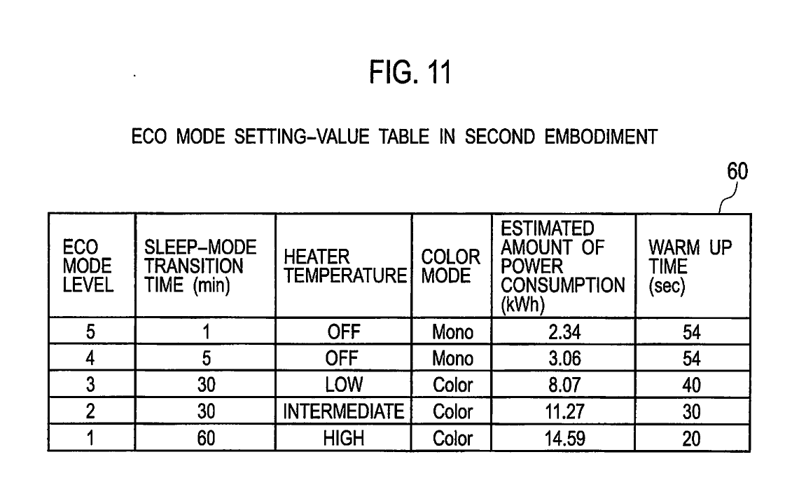

FIG. 11 is a chart illustrating eco mode setting-value table 60 according to the second embodiment. Eco mode setup table 60, is stored in flash memory 18A. In eco mode setup table 60 eco mode levels, e.g., levels 1 to 5, each includes a combination of a setting-value option for the sleep-mode transition time, a setting-value option for the heater temperature of fuser unit 13, and a selection from color printing and monochrome printing (described as “color mode” in eco mode setting-value table 60 shown in FIG. 11), as well as a value of the estimated amount of power consumption and a value of the warm-up time from the sleep mode corresponding to the combination. Both the estimated amount of power consumption and the warm-up time from the sleep mode are obtained by experiments and calculations according to the International Energy Star Program.

For instance, when the eco mode level is level 5, the sleep-mode transition time is 1 [min], the heater temperature is OFF, the color mode is monochrome, the estimated amount of power consumption is 2.34 [KWh], and the warm-up time is 54 [sec].

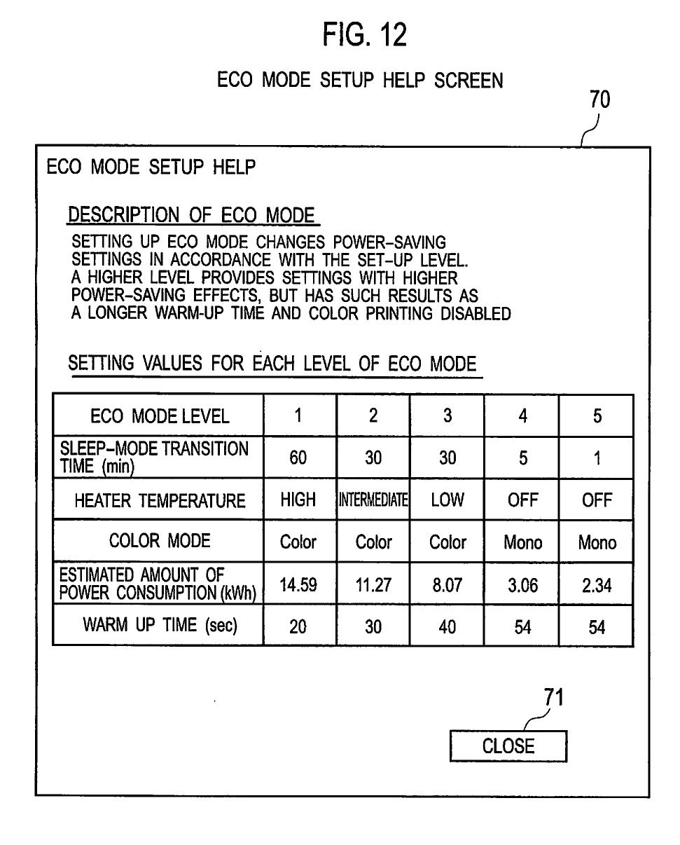

FIG. 12 is a diagram illustrating an example of eco mode setup help screen 70 displayed when help button 52 shown in FIG. 10 is pressed.

The following description of eco mode is provided in the top section of eco mode setup help screen 70.

Description of the Eco Mode

Setting up eco mode changes power-saving settings in accordance with the set-up level.

A higher level provides settings with higher power-saving effects, but has such results as a longer warm-up time and color printing disabled.”

A list of setting values for each of the different levels of the eco mode is provided from the middle section to the bottom section of eco mode setup help screen 70.

If, for instance, the eco mode level is level 1, the settings corresponding to the level are: the sleep-mode transition time is 60 [min]; the heater temperature is high; the color mode is color (indicated by “Color” in FIG. 12); the estimated amount of power consumption is 14.59 [KWh]; and the warm-up time is 20 [sec]. If the eco mode level is either level 4 or level 5, color printing is disabled, so that the color mode is set to be monochrome (indicated by “Mono” in FIG. 12).

If help button 52 shown in FIG. 10 is pressed, eco mode setup help screen 70 shown in FIG. 12 is displayed to provide the user with a guide for the eco mode setup. If close button 71 is pressed, the eco mode setup help screen is closed.

### (Operations of Second Embodiment)

The operations of this second embodiment in the following two cases are described below. In one case, the user sets up the eco mode through eco mode setup screen 50, then presses enter button 53 in eco mode setup screen 50 to set the level of the eco mode thereby setting up the related items. In the other case, the user presses help button 52 in eco mode setup screen 50 to display help screen 70 of the eco mode.

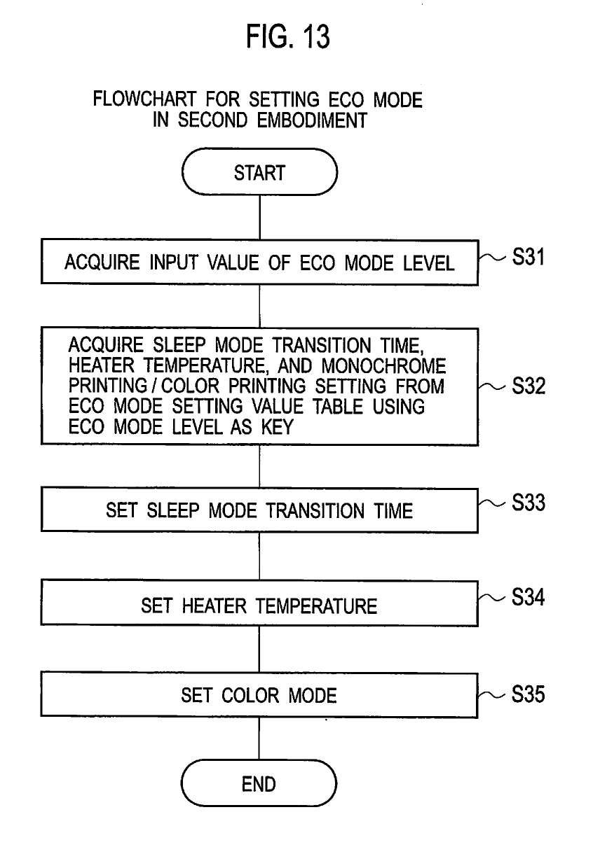

FIG. 13 is a flowchart illustrating the operations of eco mode setup program 16b at the time when an eco mode is set up according to the second embodiment.

The user calls up eco mode setup screen 50 through operation display unit 14, and eco mode setup screen 50 is displayed as shown in FIG. 10. Then, the user selects sleep mode on button 21a to set the sleep mode to be ON in printer 10A.

At step S31, the user inputs a value for the eco mode level, and eco mode setup program 16b acquires the input value. Then, at step S32, eco mode setup program 16b uses the acquired value of the eco mode level as a key to load the corresponding sleep-mode transition time [min], the corresponding heater temperature, and the corresponding selection from color printing and monochrome printing from eco mode setting-value table 60 stored in flash memory 18A.

At step S33, the sleep-mode transition time is set up on the basis of the loaded information. Then, at step S34, the heater temperature is set up, and, after that, the color mode is set up at step S35.

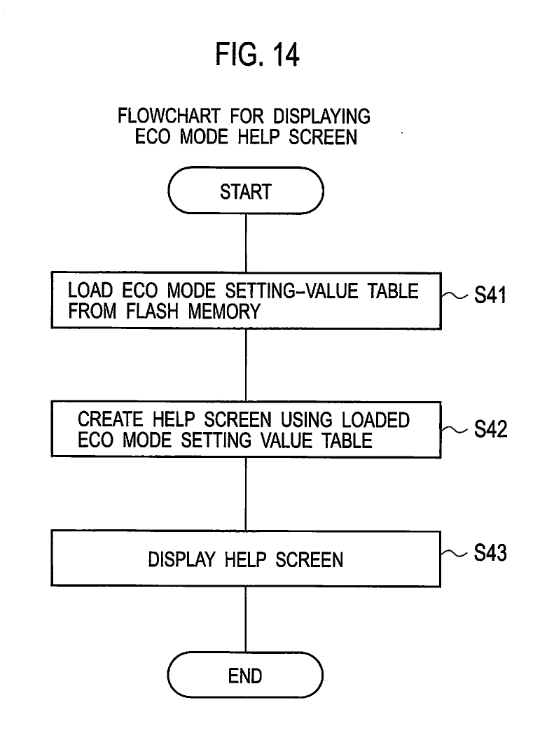

FIG. 14 is a flowchart illustrating the operations of eco mode setup program 16b at the time when eco mode setup help screen 70 is displayed.

If the user presses help button 52 in eco mode setup screen 50 shown in FIG. 10, eco mode setup program 16b loads eco mode setting-value table 60 stored in flash memory 18A at step S41.

At step S42, eco mode setup program 16b creates eco mode setup help screen 70 on the basis of the information available from loaded eco mode setting-value table 60. Then, at step S43, eco mode setup program 16b displays eco mode setup help screen 70 thus created on operation display unit 14.

### (Effects of Second Embodiment)

Print apparatus 10A according to the second embodiment has the following effects (d) and (e) in addition to the previously listed effects (a) to (c) of the first embodiment.

(d): Print apparatus 10A of the second embodiment includes eco mode setting-value table 60 where the values of setting items, the estimated amount of power consumption, and the warm-up time are set up in a batch manner for each of the eco mode levels indicating the power-saving levels in the sleep mode. Accordingly, the user can set up values of various setting items easily by selecting one of the eco mode levels with level-setup button 51 in eco mode setup screen 50.

(e): The content of eco mode setting-value table 60 is displayed in operation display unit 14, so that the setting values, the estimated amount of power consumption, and the warm-up time for each of the eco mode levels can be visually checked. Accordingly, the user can trade off the conveniences and the power-saving more easily and adequately.

### (Modifications)

The invention is not limited to the above-described first and second embodiments and various other applications and modifications can be made. The following cases (1) and (2) are some of the examples of such applications and modifications.

(1): Both of printers 10 and 10A in the first and the second embodiments are exemplarily described as page printers. The invention is not limited to page printers. For instance, the invention is applicable to thermal printers, inkjet printers, dot-impact printers, and the like. In addition, the invention is also applicable to fax machines, photocopiers, multifunction machines, and the like equipped with printer units with similar configurations to those of printers 10 and 10A.

(2): Operation display unit 14 in the first and the second embodiments is described as an LCD equipped with touch panels, but devices other than such LCD may be used to separately provide an operation unit and a display unit.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A printer having operational modes including a sleep mode in which power consumption is saved, the printer comprising:
an operation display unit configured to receive data inputted by a user and to display a notification to the user;
a sleep-mode setting-value table in which a warm-up time from the sleep mode and an estimated amount of power consumption per certain unit of time in the sleep mode are stored in association with each combination of values for setting items to set up conditions of the sleep mode; and
a first setup unit configured to, when setting up the conditions of the sleep mode, extract the estimated amount of power consumption and the warm-up time in reference to the sleep-mode setting-value table by using, as a key, values of the setting items inputted by the user through the operation display unit, display the extracted estimated amount of power consumption and warm-up time in the operation display unit, and confirm the values of the setting items in the operation display unit as the set-up values in response to an operation by the user through the operation display unit.

2. The printer according to claim 1, wherein the estimated amount of power consumption per certain unit of time in the sleep mode is a value calculated beforehand using the values of the setting items as variables on the basis of a predetermined standard defining an energy-saving criterion.

3. The printer according to claim 2, wherein the predetermined standard is a standard specified by the International Energy Star Program and defines the amount of power consumption per certain unit of time on the basis of a characteristic and printing speed of the printer.

4. The printer according to claim 1 further comprising:
a fuser unit including a heater and configured to apply heat and pressure to fix toner to a print medium;
an operation-panel backlight configured to illuminate the operation display unit from a backside of the operation display unit; and
a controller configured to cut off or reduce power supply to the heater and the operation-panel backlight in the sleep mode.

5. The printer according to claim 4, wherein the setting items include:
a transition time from a completion of a last print job to a transition to the sleep mode; and
a heater temperature of the heater.

6. The printer according to claim 1, wherein the setting items include a transition time from the completion of the last print job to a transition to the sleep mode.

7. The printer according to claim 4, wherein the setting items include a heater temperature of the heater.

8. The printer according to claim 5, wherein the first setup unit searches the sleep-mode setting-value table by using the set-up value of the heater temperature as a key, thereby extracts combinations of the transition time, the estimated amount of power consumption, and the warm-up time corresponding to the heater temperature, and displays the extracted combinations in the operation display unit.

9. The printer according to claim 5, wherein the first setup unit searches the sleep-mode setting-value table by using the set-up value of the transition time as a key, thereby extracts combinations of the heater temperature, the estimated amount of power consumption, and the warm-up time corresponding to the transition time, and displays the extracted combinations on the operation display unit.

10. A printer having operational modes including a sleep mode in which power consumption is saved, the printer comprising:
an operation display unit configured to receive data inputted by a user and to display a notification to the user;
an eco mode setting-value table in which eco mode levels with different power saving levels are stored and values of setting items, an estimated amount of power consumption, and a warm-up time which are set for each eco mode level are stored; and
a second setup unit configured to, when setting up the conditions of the sleep mode, extract the values of the setting items in reference to the eco mode setting-value table by using, as a key, the eco mode level inputted by the user through the operation display unit, and confirm the extracted values of the setting items as the set-up values.

11. The printer according to claim 10 further comprising:
a fuser unit including a heater and configured to apply heat and pressure to fix toner to a print medium;
an operation-panel backlight configured to illuminate the operation display unit from a backside of the operation display unit; and
a controller configured to cut off or reduce power supply to the heater and the operation-panel backlight in the sleep mode.

12. The printer according to claim 11, wherein the setting items include:
a transition time from a completion of the last print job to a transition to the sleep mode;
a heater temperature of the heater; and
a selection from color printing and monochrome printing.

13. The printer according to claim 10, wherein the setting items include a transition time from a completion of a last print job to a transition to the sleep mode.

14. The printer according to claim 10, wherein the setting items include a heater temperature of the heater.

15. The printer according to claim 11, wherein the setting items include a selection from color printing and monochrome printing.

16. The printer according to claim 10, wherein when the user performs a predetermined operation through the operation display unit, the second setup unit displays, on the operation display unit, combinations of values of the setting items, the estimated amount of power consumption, and the warm-up time on the basis of the eco mode setup table, the combinations respectively set for the eco mode levels.

17. The printer according to claim 1, wherein the operational modes include a print mode, a standby mode, and the sleep mode.

18. The printer according to claim 10, wherein the operational modes include a print mode, a standby mode, and the sleep mode.
